(19) United States
(12) Patent Application Publication
(10) Pub. No.: US 2009/0002061 A1
(43) Pub. Date: Jan. 1, 2009

(54) BIAS SUPPLY, START-UP CIRCUIT, AND START-UP METHOD FOR BIAS CIRCUIT

(75) Inventors: Leaf Chen, Taipei City (TW); Chih-Shun Lee, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: BEYOND INNOVATION TECHNOLOGY CO., LTD., Taipei City (TW)

(21) Appl. No.: 12/052,739

(22) Filed: Mar. 21, 2008

(30) Foreign Application Priority Data
Jun. 27, 2007 (TW) 96123200

(51) Int. Cl. G05F 3/26

(52) U.S. Cl. 327/537

(57) ABSTRACT

A bias supply, a start-up circuit, and a start-up method for a bias circuit are provided. The bias supply includes the bias circuit, an impedance unit, a charge storage unit, and a switch. The impedance unit is coupled between a first voltage and a node. The charge storage unit is coupled between the node and a second voltage. The switch decides whether or not to output a start-up voltage to the bias circuit according to the voltage of the node. In other words, charge/discharge properties of the charge storage unit are utilized for controlling whether the switch outputs a start-up voltage to the bias circuit or not. Therefore, the power consumption of the start-up circuit is decreased.

### CROSS-REFERENCE TO RELATED APPLICATION

This application claims the priority benefit of Taiwan application serial no. 96123200, filed on Jun. 27, 2007. The entirety of the above-mentioned patent application is hereby incorporated by reference herein and made a part of this specification.

### BACKGROUND OF THE INVENTION

1. Field of the Invention

The present invention generally relates to a bias supply, in particular, to a start-up technique of a bias supply.

2. Description of Related Art

Current mirrors are usually used as the bias circuits. The bias circuits need start-up circuits to operate normally.

FIG. 1 is a circuit diagram of a conventional bias supply. Referring to FIG. 1, the bias supply 10 is divided into two parts, namely a bias circuit 20 and a start-up circuit 30. The bias circuit 20 includes current mirrors 40, 41 and a resistor 130. The current mirror 40 is constituted by N-channel MOS transistors 110, 111. The transistor 110 has a drain and a gate coupled to the drain. The transistors 110, 111 have different channel width/length ratios. The resistor 130 is used to provide a voltage difference, and thus the current mirror 40 may produce a current. The current mirror 41 is constituted by P-channel MOS transistors 120, 121. The transistor 121 has a drain and a gate coupled to the drain. The start-up circuit 30 is constituted by a P-channel MOS transistor 130 and N-channel MOS transistors 131, 132, 133. The transistors 130, 131, 132, 133 are equivalent to diodes respectively.

The bias circuit 20 has two stable states, namely a zero stable state and a saturated stable state. At the beginning of supplying a voltage Vdd to the bias circuit 20, the bias circuit 20 is at the zero stable state, a node B remains at a voltage of a relatively low potential, and a node C remains at a voltage of a relatively high potential. After the node B receives a start-up voltage of a relatively high potential or the node C receives a voltage of a relatively low potential, the bias circuit 20 transits from the zero stable state to the saturated stable state, thereby providing a stable bias to other circuits.

In order to provide the start-up voltage to the bias circuit 20, the start-up circuit 30 provides a bias VB to the node A through transistors 130, 131, 132, so as to conduct the transistor 133 and further provide the start-up voltage of a relatively high potential to the node B. When the bias circuit 20 transits into the saturated stable state, the bias of the node B is higher than that of the node A, and thus the transistor 133 equivalent to the diode is turned off to prevent the bias circuit 20 from being interfered by the start-up circuit 30. It should be noted that the transistors 130, 131, 132 of the start-up circuit 30 are normally conducted. In other words, even if the bias circuit 20 is started up, the transistors 130, 131, 132 remain in conducting state, so that a power consumption of the start-up circuit 30 is very large.

FIG. 2 is a circuit diagram of another conventional bias supply. Referring to FIG. 2, the bias supply 11 is divided into two parts, namely a bias circuit 20 and a start-up circuit 31. The bias circuit 20 conforms to the above description. It should be noted that the start-up circuit 31 is constituted by an inverter 50 and an N-channel MOS transistor 212. The N-channel MOS transistor 212 may be regarded as a switch. The inverter 50 is constituted by a P-channel MOS transistor 210 and an N-channel MOS transistor 211.

When the bias circuit 20 is at the zero stable state, the node B remains at a voltage of a relatively low potential. The start-up circuit 31 inputs the bias of the node B to the inverter 50 based on a feedback technique. Therefore, the inverter 50 outputs a voltage of a relatively high potential to the node A, so as to conduct the transistor 212. When the transistor 212 is conducted, the voltage of the node C is dropped to a voltage of a relatively low potential, such that the bias circuit 20 transits from the zero stable state into the saturated stable state.

Based on the above, when the bias circuit 20 is at the saturated stable state, the node B remains at a voltage of a relatively high potential. The start-up circuit 31 uses the inverter 50 to keep the voltage of the node A at the voltage of a relatively low potential, and thus the transistor 212 is in the turn-off state. In this manner, the bias circuit 20 will not be interfered by the start-up circuit 31. It should be noted that when the bias circuit 20 is at the saturated stable state, the voltage of the relatively high potential of the node B is about 4 V to 8 V. If the voltage Vdd is much higher than the voltage of the node B, for example the voltage Vdd is 20V, the inverter 50 cannot turn off the transistor 212. Therefore, the severe current leakage of the start-up circuit 31 occurs, and the bias circuit 20 is interfered by of the start-up circuit 31 and cannot operate normally. In other words, the start-up circuit 31 in the conventional art can only be used at a relatively low voltage Vdd.

### SUMMARY OF THE INVENTION

The present invention is directed to a bias supply, for waking up the bias circuit to operate normally.

The present invention is directed to a start-up circuit for alleviating current leakage.

The present invention is directed to a start-up method for a bias circuit, in which whether or not to provide a start-up voltage to the bias circuit is decided according to charge/discharge properties of the capacitor, thereby reducing the power consumption.

The present invention is directed to a bias supply, which includes a bias circuit, an impedance unit, a charge storage unit, and a switch. The bias circuit is coupled between a first voltage and a second voltage. The impedance unit is coupled between the first voltage and a node. The charge storage unit is coupled between the node and the second voltage. The switch decides whether or not to output a start-up voltage to the bias circuit according to the voltage of the node.

In an embodiment of the present invention, the bias supply further includes a buffer coupled between the node and the switch, for providing the voltage of the node to the switch. In another embodiment, the bias supply further includes an inverter coupled between the node and the switch, for providing a reverse voltage of the node to the switch. In still another embodiment, the inverter includes a first and a second transistor. The first transistor includes a first terminal, a second terminal, and a gate coupled to the first voltage, the switch, and the node respectively. The second transistor includes a first terminal, a second terminal, and a gate coupled to the switch, the second voltage, and the node respectively. In yet another embodiment, the first transistor is a P-channel MOS transistor, and the second transistor is an N-channel MOS transistor.

In an embodiment of the present invention, the bias circuit includes a first and a second current mirror. The first current mirror is coupled to the first voltage, and includes a first transistor and a second transistor. The first transistor includes a first terminal coupled to the first voltage, and a second terminal coupled to a gate. The second transistor includes a first terminal and a gate respectively coupled to the first terminal and the gate of the first transistor. The second current mirror is coupled between the first current mirror and the second voltage, and includes a third and a fourth transistor. The third transistor includes a first terminal and a second terminal coupled to the second terminal of the first transistor and the second voltage respectively. The fourth transistor includes a first terminal and a gate coupled to the second terminal of the second transistor, and a second terminal coupled to the second voltage. The third transistor and the fourth transistor have different channel width/length ratios. The bias circuit is used to provide a stable bias.

Based on the above, in another embodiment, when the first terminal of the third transistor receives a start-up voltage, the bias circuit transits from a zero stable state to a saturated stable state to provide a stable bias. In still another embodiment, the start-up voltage is the second voltage. In still another embodiment, when the first terminal of the fourth transistor receives a start-up voltage, the bias circuit transits from a zero stable state to a saturated stable state to provide a stable bias. In yet another embodiment, the start-up voltage is the first voltage. In another embodiment, the first and second transistors are P-channel MOS transistors, and the third and fourth transistors are N-channel MOS transistors.

In an embodiment of the present invention, the impedance unit includes a resistor coupled between the first voltage and the node. In another embodiment, the charge storage unit includes a capacitor coupled between the node and the second voltage. When the capacitor is at a charge state, the start-up voltage is output to the bias circuit, and when the capacitor is at a saturated state, the outputting of the start-up voltage to the bias circuit is stopped. In still another embodiment, the charge storage unit includes a first transistor. The first transistor includes a first terminal and a second terminal coupled to the second voltage, and a gate coupled to the node. In yet another embodiment, the switch includes a first transistor. The first transistor includes a first terminal, a second terminal, and a gate coupled to the bias circuit, a third voltage, and the node. Whether or not to conduct the first terminal and the second terminal of the first transistor is decided according to the voltage of the node.

From another point of view, the present invention provides a start-up circuit, for starting up the bias circuit. The start-up circuit includes an impedance unit, a charge storage unit, and a switch. The impedance unit includes a first terminal and a second terminal coupled to a first voltage and a node respectively. The charge storage unit includes a first terminal and a second terminal coupled to the node and a second voltage respectively. The switch decides whether or not to provide a start-up voltage to the bias circuit according to the voltage of the node.

From another point of view, the present invention provides a start-up method for a bias circuit, which includes charging a charge storage unit through an impedance unit. When the charge storage unit is at a charge state, the start-up voltage is output to the bias circuit, and when the charge storage unit is at a saturated state, the outputting of the start-up voltage to the bias circuit is stopped.

In an embodiment, when the capacitor is at a charge state, the node coupled to the capacitor is at a first voltage so as to conduct the switch to allow outputting the start-up voltage to bias circuit. When the capacitor is at a saturated state, the node is at a second voltage so as to turn off the switch to stop outputting the start-up voltage to bias circuit.

In the present invention, the impedance unit is coupled between the first voltage and the node, and the charge storage unit is coupled between the node and the second voltage. Moreover, the switch decides whether or not to output the start-up voltage to the bias circuit according to the voltage of the node. In other words, the present invention utilizes charge/discharge properties of the charge storage unit for controlling whether the switch outputs the start-up voltage to the bias circuit or not. Therefore, the power consumption of the start-up circuit is reduced.

In order to make the aforementioned and other objectives, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional bias supply.

FIG. 2 is a circuit diagram of another conventional bias supply.

FIG. 3 is a circuit diagram of a bias supply according to a first embodiment of the present invention.

FIG. 4 is a flow chart of a start-up method for a bias circuit according to the first embodiment of the present invention.

FIG. 5A is a circuit diagram of a bias supply according to a second embodiment of the present invention.

FIG. 5B is a circuit diagram of a bias supply according to a third embodiment of the present invention.

FIGS. 5C and 5D are circuit diagrams of another bias supply according to the third embodiment of the present invention.

FIG. 6A is a circuit diagram of a bias supply according to a fourth embodiment of the present invention.

FIGS. 6B, 6C and 6D are circuit diagrams of another bias supply according to the fourth embodiment of the present invention.

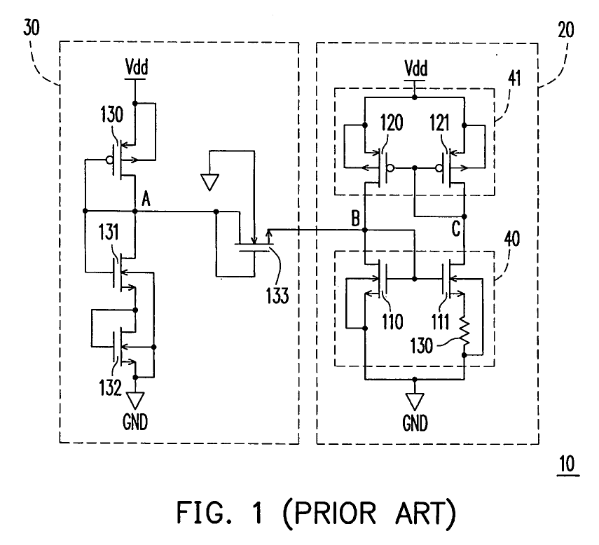

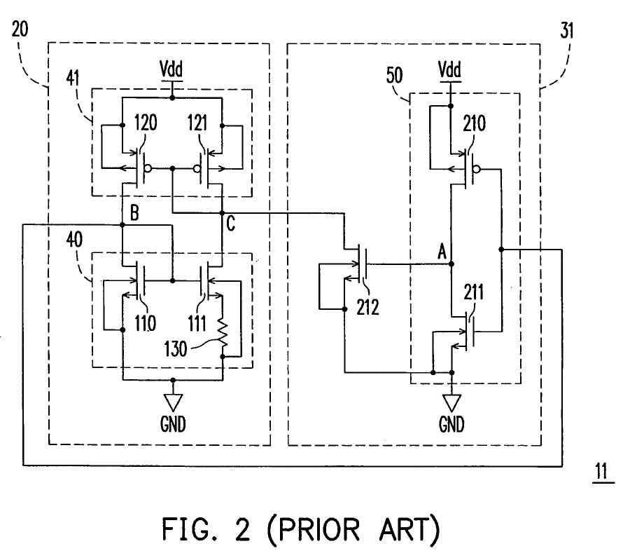

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

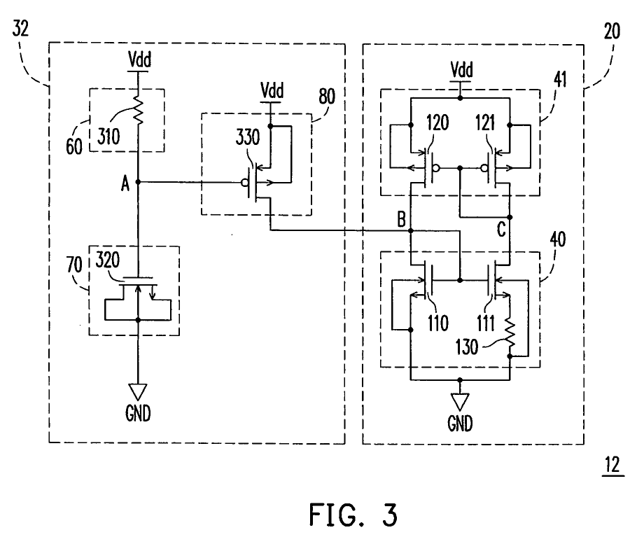

FIG. 3 is a circuit diagram of a bias supply according to a first embodiment of the present invention. Referring to FIG. 3, the bias supply 12 includes a bias circuit 20 and a start-up circuit 32. The bias circuit 20 includes current mirrors 40, 41. The current mirror 40 includes, for example, N-channel MOS transistors 110, 111 and a resistor 130. The transistor 110 has a drain and a gate coupled to the drain, and the transistors 110, 111 have different channel width/length ratios. The resistor 130 is used to provide a voltage difference, and thus the current mirror 40 may produce a current. The current mirror 41 includes, for example, P-channel MOS transistors 120, 121. The transistor 121 has a drain and a gate coupled to the drain.

Generally speaking, the bias circuit 20 has two stable states, namely a zero stable state and a saturated stable state. At the beginning of supplying a voltage Vdd to the bias circuit 20, the bias circuit 20 is at the zero stable state, a node B remains at a voltage of a relatively low potential, and a node C remains at a voltage of a relatively high potential. After the node B receives the start-up voltage (e.g., the voltage Vdd) of a relatively high potential or the node C receives a voltage (e.g., grounding) of a relatively low potential, the bias circuit 20 transits from the zero stable state to the saturated stable state, thereby providing a stable bias to other circuits. Persons skilled in the art should know that the bias circuit 20 may have different forms according to different requirements of the designer. For example, the bias circuit 20 may also be formed by three cascaded current mirrors. In other words, the form of the bias circuit is not limited in the present invention.

The start-up circuit 32 includes an impedance unit 60, a charge storage unit 70, and a switch 80. In this embodiment, the impedance unit 60 is implemented by a resistor 310, but in other embodiments, the impedance unit 60 may be a transistor. The resistor 310 is coupled between the voltage Vdd and a node A. The charge storage unit 70 includes, for example, an N-channel MOS transistor 320, the transistor 320 has a gate coupled to the node A, and a source and a drain grounded. Therefore, the transistor 320 is equivalent to a capacitor. In this embodiment, the charge storage unit 70 implemented by the transistor 320 has the advantages that the transistor 320 has a quite small volume and may be fabricated with a low cost. In other embodiments, the charge storage unit 70 may also be implemented by a capacitor. The switch 80 is, for example, but not limited to, a P-channel MOS transistor 330. In other embodiment, the switch 80 may be implemented by an electronic switch of any type. The resistor 330 has a gate, a source, and a drain coupled to the node A, the voltage Vdd, and the node B. Whether or not to conduct the source and the drain of the transistor 330 is decided according to the voltage of the node A. Hereinafter, the operation manner of the start-up circuit 32 is further illustrated in detail.

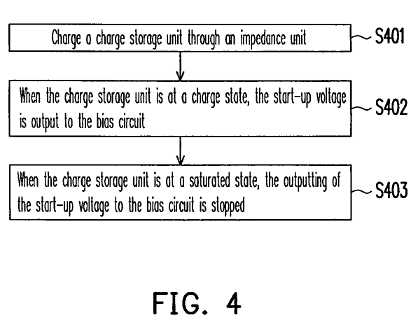

FIG. 4 is a flow chart of a start-up method for a bias circuit according to the first embodiment of the present invention. Referring to FIGS. 3 and 4, first, in Step S401, a voltage Vdd (e.g., 20 V) is provided to the start-up circuit 32 and the bias circuit 20, so as to charge the transistor 320 through the resistor 310. In this embodiment, the voltage Vdd is, for example, 20 V for illustration, but in other embodiments, the voltage Vdd may be changed as required, for example, between 3 V and 20 V. When the transistor 320 is at a charge state, the voltage of the node A rises from 0 V to the voltage Vdd minus a cross voltage of the resistor 310. In other words, at the beginning of charging the transistor 320, the voltage of the node A is quite low. Thus, the transistor 330 is in the conducting state to output a start-up voltage of a relatively high potential to the node B of the bias circuit 20 (Step S402). In this manner, the start-up circuit 32 may wake up the bias circuit 20 to transit from the zero stable state into the saturated stable state, thereby providing a stable bias to other circuits.

Based on the above, when the transistor 320 is charged to the saturated state, or more exactly, when the transistor 320 is continuously charged until the voltage of the node A rises to be able to turn off the transistor 330, the start-up circuit 32 stops outputting the start-up voltage to the bias circuit 20 (Step S403). Thus, the start-up circuit 32 has no interference on the operation of the bias circuit 20.

Moreover, when the transistor 320 is charged to the saturated state, the circuitry between the gate and the source/drain of the transistor 320 is regarded to be open, and thus almost no current flows from the gate to the source/drain of the transistor 320, thereby alleviating the current leakage of the start-up circuit 32, and further reducing the power consumption of the bias supply 12. Furthermore, it takes some time to charge the transistor 320. In other words, in this period, the start-up circuit 32 continuously provides a start-up voltage to the bias circuit 20, so as to ensure the bias circuit 20 can enter the saturated stable state. Furthermore, in this embodiment, two transistors and one resistor are used to realize the start-up circuit 32, which achieves a great saving in circuit cost as compared with the conventional art.

It should be noted that although a possible form of the bias supply, the start-up circuit, and the start-up method for a bias circuit has been described in the above embodiments, persons of ordinary skill in the art should know that the manufacturers have different designs of the bias supply, the start-up circuit, and the start-up method for a bias circuit, and thus the application of the present invention is not limited to the possible form. In other words, it conforms to the spirit of the present invention as long as the charge/discharge properties of the capacitor are used for controlling the start-up of the bias circuit. Hereinafter, more embodiments are illustrated to allow the persons of ordinary skill in the art further to know the spirit of the present invention, and thus to implement the present invention.

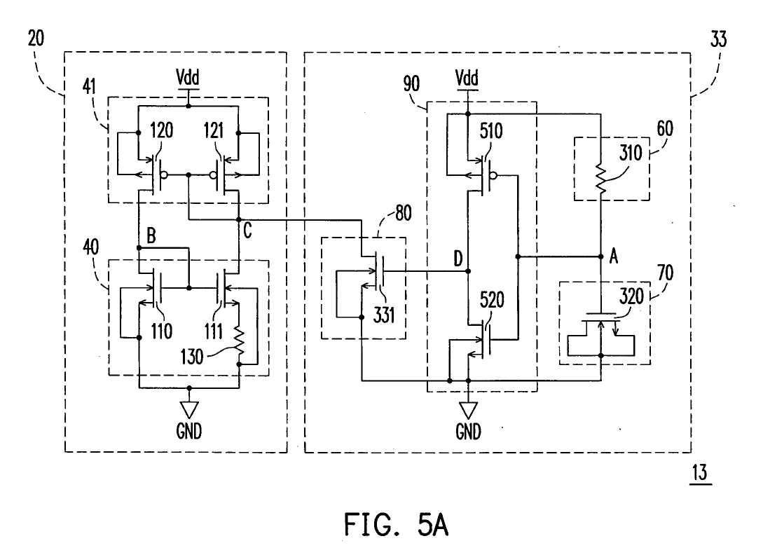

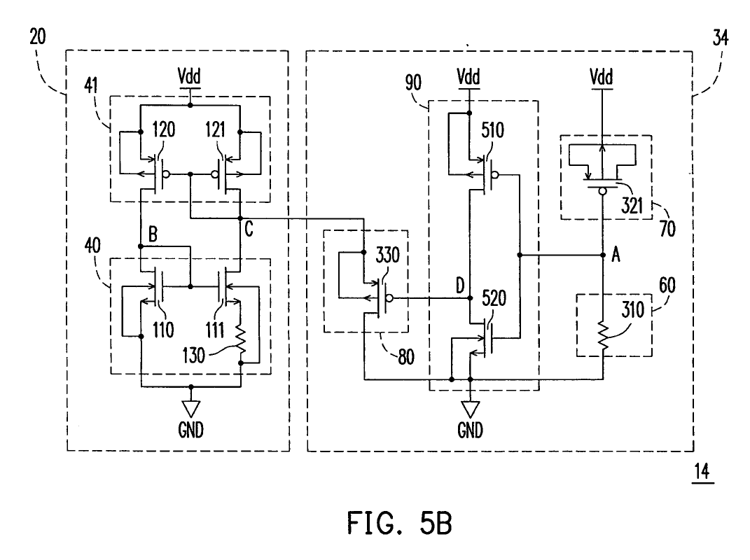

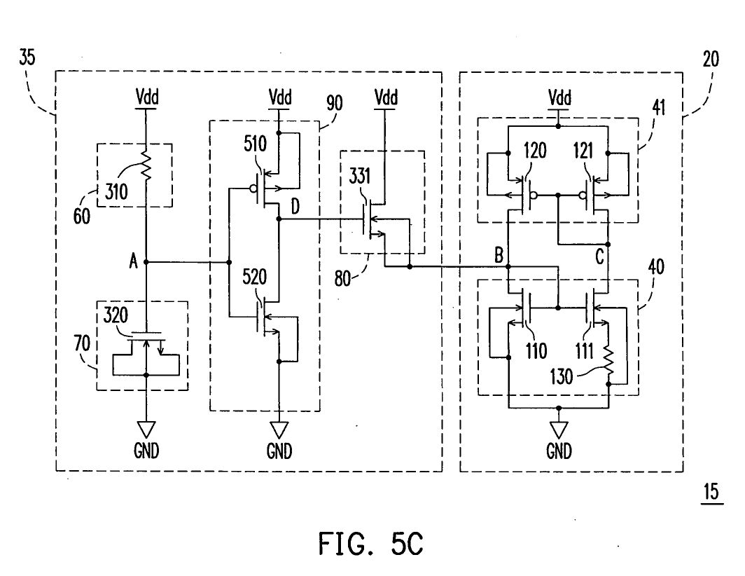

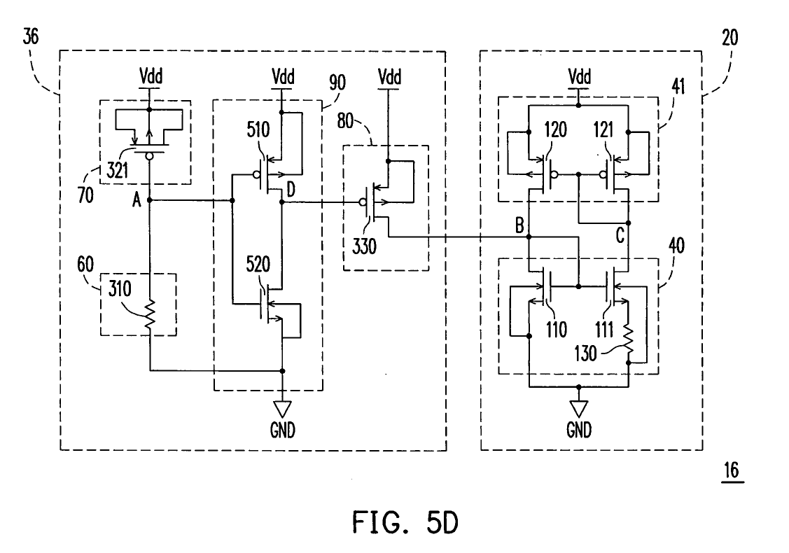

Persons skilled in the art may add an inverter between the node A and the switch, and appropriately adjust the circuit architecture, so as to alleviate the voltage bias. For example, FIG. 5A is a circuit diagram of a bias supply according to a second embodiment of the present invention. Referring to FIG. 5A, the elements with the same element numerals appearing in the above embodiments conform to the description of the above embodiments. In this embodiment, an inverter 90 is added between the node A and the switch 80. The inverter 90 is, for example, but not limited to, a P-channel MOS transistor 510 and an N-channel MOS transistor 520. Moreover, the start-up circuit 32 in FIG. 3 outputs a start-up voltage of a high potential to start up the bias circuit 20. In this embodiment, the start-up circuit 33 outputs a start-up voltage of a low potential to start up the bias circuit 20 through the node C. Therefore, the switch 80 is implemented by the N-channel MOS transistor 331. Hereinafter, the operation of the bias supply 13 is illustrated in detail.

First, a voltage Vdd (e.g., 20 V) is supplied to the start-up circuit 33 and the bias circuit 20, so as to charge the transistor 320 through the resistor 310. When the transistor 320 is at a charge state, the voltage of the node A rises from 0 V to the voltage Vdd minus a cross voltage of the resistor 310. In other words, at the beginning of charging the transistor 320, the voltage of the node A is quite low. Then, by the use of the inverter 90, the node D may remain at the voltage of a relatively high potential. Therefore, the transistor 331 is in the conducting state to output the start-up voltage of a relatively low potential to the node C of the bias circuit 20. In this manner, the start-up circuit 33 may wake up the bias circuit 20 to transit from the zero stable state to the saturated stable state, thereby providing a stable bias to other circuits.

Based on the above, when transistor 320 is charged to the saturated state, the voltage at the node A is sufficient to make the output terminal of the inverter 90 to transit states. In other words, when the transistor 320 is charged to the saturated state, the node A is at a voltage of a relatively high potential, the node D is at a voltage of a relatively low potential, and the transistor 331 is in the turn-off state. Thus, the start-up circuit 33 has no interference on the operation of the bias circuit 20.

Moreover, when the transistor 320 is charged to the saturated state, the circuitry between the gate and the source/drain of the transistor 320 is regarded to be open, and thus almost no current flows from the gate to the source/drain of the transistor 320, thereby reducing the power consumption of the bias supply 13. Furthermore, in this embodiment, the inverter 90 is used to alleviate the voltage bias of the node A. In other words, the inverter 90 is used to maintain the node D at a stable voltage level, for controlling whether or not to turn on the switch 80.

Persons of ordinary skill in the art may also change the charging direction of the charge storage unit 70. For example, FIG. 5B is a circuit diagram of a bias supply according to a third embodiment of the present invention. Referring to FIG. 5B, the elements with the same element numerals appearing in the above embodiments conform to the description of the above embodiments. In this embodiment, the charge storage unit 70 is implemented by a P-channel MOS transistor 321, and the transistor 321 has a source/drain coupled to the voltage Vdd, and a gate coupled to the node A. The resistor 310 is coupled between the node A and the ground terminal. At the beginning of charging the transistor 321, the node A is at a voltage of a relatively high potential. After the transition of the inverter 90, the node D is at a voltage of a relatively low potential. Then, the transistor 330 is conducted, and the node C receives the voltage of a relatively low potential. The bias circuit 20 is waken up and remains at a stable saturated state.

When the transistor 321 is charged to the saturated state, the node A is at a voltage of a relatively low potential. After the transition of the inverter 90, the node D is at a voltage of a relatively high potential. Then, the transistor 330 is turned off, and the bias circuit 20 is not interfered by the start-up circuit 34. In this manner, the similar effect of the above embodiment is achieved. In the similar way, the bias supply may have other forms. For example, FIGS. 5C and 5D are circuit diagrams of another bias supply according to the third embodiment of the present invention. The operation principle of the bias supplies 15 and 16 conform to the above embodiments, and will not be described herein again.

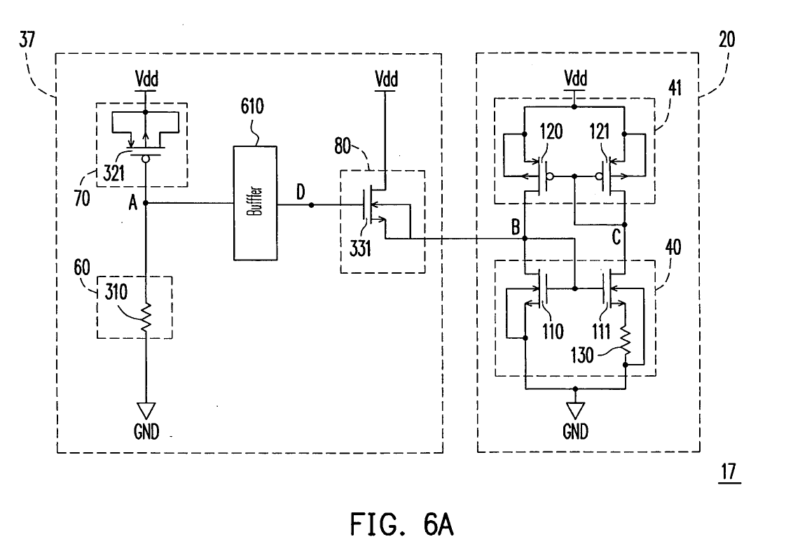

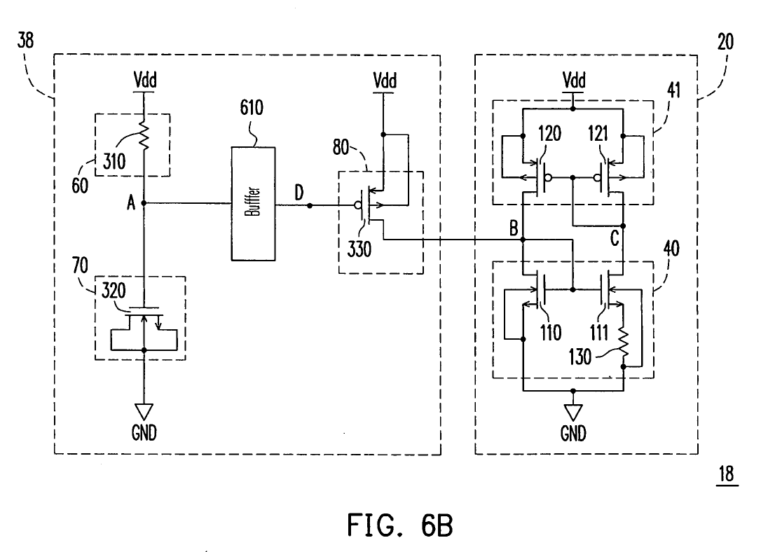

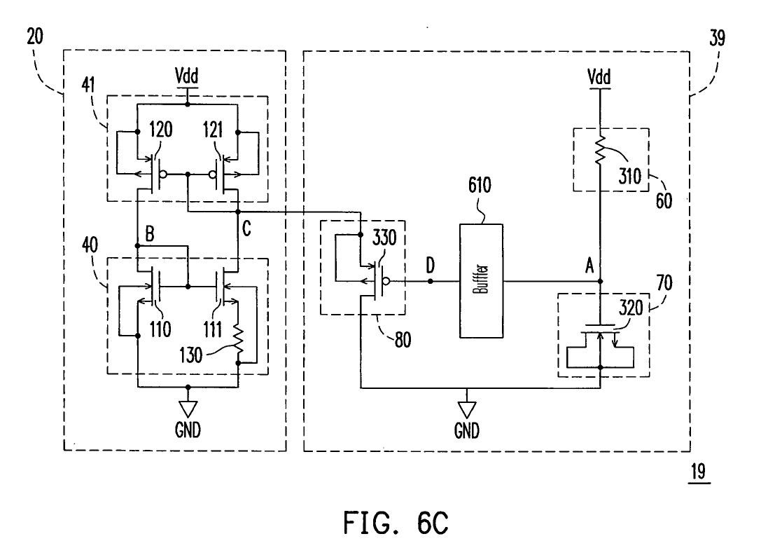

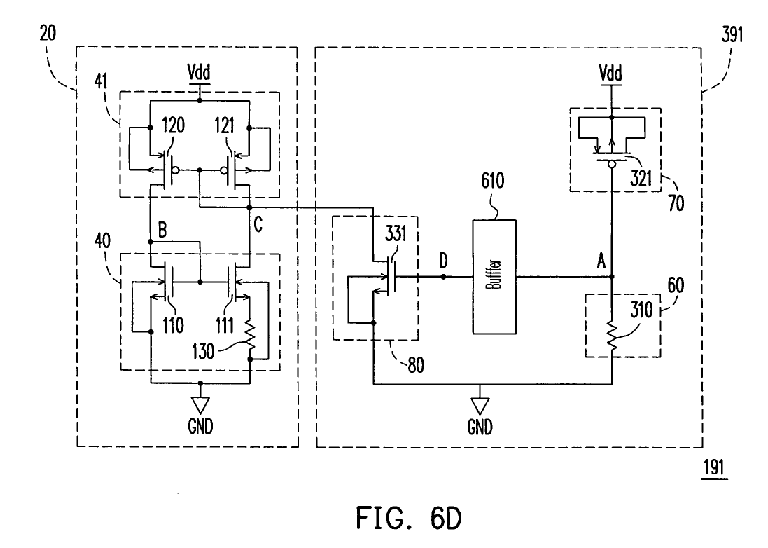

Persons skilled in the art may also add a buffer between the node A and the switch, and appropriately adjust the circuit architecture, so as to further ensure that the bias circuit can be waken up. For example, FIG. 6A is a circuit diagram of a bias supply according to a fourth embodiment of the present invention. Referring to FIG. 6A, the elements with the same element numerals appearing in the above embodiments conform to the description of the above embodiments. In this embodiment, a buffer 610 is added between the node A and the switch 80. The buffer 610 is, for example, but not limited to, constituted by two cascaded inverters. At the beginning of charging the transistor 321, the node A is at a voltage of a relatively high potential. Then, the buffer 610 provides a stable voltage of a relatively high potential to the node D. Thus, the transistor 331 is conducted, and the node B receives the voltage of a relatively high potential. The bias circuit 20 is waken up and remains at a saturated stable state.

When the transistor 321 is charged to the saturated state, the node A is at a voltage of a relatively low potential. The buffer 610 provides a voltage of a relatively low potential to the node D. Then, the transistor 330 is turned off, and the bias circuit 20 is not interfered by the start-up circuit 34. In this manner, the similar effect of the above embodiment can be achieved. In the similar way, the bias supply may have other forms. For example, FIGS. 6B, 6C, and 6D are circuit diagrams of another bias supply according to the fourth embodiment of the present invention. The operation principle of the bias supplies 18, 19, 191 conform to the above embodiments, and will not be described herein again.

In view of the above, the present invention utilizes charge/discharge properties of the charge storage unit for controlling whether the switch outputs a start-up voltage to the bias circuit or not. Therefore, the power consumption of the start-up circuit is reduced. Moreover, the embodiments of the present invention at least have the following advantages.

1. When the charge storage unit is at the charge state, the start-up circuit continuously provides a start-up voltage to the bias circuit, so as to ensure that the bias circuit can enter the saturated stable state.

2. When the charge storage unit is charged to the saturated state, the start-up circuit stops outputting the start-up voltage to the bias circuit, so as to prevent the start-up circuit from interfering the normal operation of the bias circuit.

3. When the charge storage unit is charged to the saturated state, the two ends of the charge storage unit are regarded to be open, thus greatly alleviating the current leakage.

4. The inverter or the buffer is used to provide a stable voltage level, for controlling whether or not to turn on the switch.

5. The charge storage unit is implemented by a transistor, and thus the circuit area and the cost are reduced.

6. Two transistors and a resistor, or three transistors are used to realize the start-up circuit, thus greatly reducing the cost of the start-up circuit.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims and their equivalents.

What is claimed is:

1. A circuit, comprising:
a bias circuit, coupled between a first voltage and a second voltage;
an impedance unit, coupled between the first voltage and a node;
a charge storage unit, coupled between the node and the second voltage; and
a switch, deciding whether or not to output a start-up voltage to the bias circuit according to a voltage of the node.

2. The circuit according to claim 1, further comprising:
a buffer, coupled between the node and the switch, for providing the voltage of the node to the switch.

3. The circuit according to claim 1, further comprising:
an inverter, coupled between the node and the switch, for providing a reverse voltage of the node to the switch.

4. The circuit according to claim 3, wherein the inverter comprises:
a first transistor, comprising a first terminal, a second terminal, and a gate coupled to the first voltage, the switch, and the node respectively; and
a second transistor, comprising a first terminal, a second terminal, and a gate coupled to the switch, the second voltage, and the node respectively.

5. The circuit according to claim 4, wherein the first transistor is a P-channel MOS transistor, and the second transistor is an N-channel MOS transistor.

6. The circuit according to claim 1, wherein the bias circuit comprises:
a first current mirror, coupled to the first voltage, comprising:
a first transistor, comprising a first terminal coupled to the first voltage, and a second terminal and a gate coupled to the second terminal; and
a second transistor, comprising a first terminal and a gate coupled to the first terminal and the gate of the first transistor respectively;
a second current mirror, coupled between the first current mirror and the second voltage, comprising:
a third transistor, comprising a first terminal and a second terminal coupled to the second terminal of the first transistor and the second voltage respectively; and
a fourth transistor, comprising a first terminal and a gate coupled to the second terminal of the second transistor, and a second terminal coupled to the second voltage, wherein the third transistor and the fourth transistor have different channel width/length ratios,
wherein the bias circuit is used to provide a stable bias.

7. The circuit according to claim 6, wherein when the first terminal of the third transistor receives the start-up voltage, the bias circuit transits from a zero stable state to a saturated stable state and provides the stable bias.

8. The circuit according to claim 7, wherein the start-up voltage is the second voltage.

9. The circuit according to claim 6, wherein when the first terminal of the fourth transistor receives the start-up voltage, the bias circuit transits from a zero stable state to a saturated stable state and provides the stable bias.

10. The circuit according to claim 9, wherein the start-up voltage is the first voltage.

11. The circuit according to claim 6, wherein the first and second transistors are P-channel MOS transistors, and the third and fourth transistors are N-channel MOS transistors.

12. The circuit according to claim 1, wherein the impedance unit comprises:
a resistor, coupled between the first voltage and the node.

13. The circuit according to claim 1, wherein the charge storage unit comprises:
a capacitor, coupled between the node and the second voltage, wherein the start-up voltage is output to the bias circuit when the capacitor is at a charge state, and the outputting of the start-up voltage to the bias circuit is stopped when the capacitor is at a saturated state.

14. The circuit according to claim 1, wherein the charge storage unit comprises:
a first transistor, comprising a first terminal and a second terminal coupled to the second voltage, and a gate coupled to the node.

15. The circuit according to claim 1, wherein the switch comprises:
a first transistor, comprising a first terminal, a second terminal, and a gate coupled to the bias circuit, a third voltage, and the node respectively, wherein whether or not to conduct the first terminal and the second terminal of the first transistor is decided according to the voltage of the node.

16. A circuit, comprising:
an impedance unit, comprising a first terminal and a second terminal coupled to a first voltage and a node respectively;
a charge storage unit, comprising a first terminal and a second terminal coupled to the node and a second voltage respectively; and
a switch, deciding whether or not to provide a start-up voltage to the bias circuit according to a voltage of the node.

17. The circuit according to claim 16, further comprising:
a buffer, coupled between the node and the switch, for providing the voltage of the node to the switch.

18. The circuit according to claim 16, further comprising:
an inverter, coupled between the node and the switch, for providing a reverse voltage of the node to the switch.

19. The circuit according to claim 18, wherein the inverter comprises:
a first transistor, comprising a first terminal, a second terminal, and a gate coupled to the first voltage, the switch, and the node respectively; and
a second transistor, comprising a first terminal, a second terminal, and a gate coupled to the switch, the second voltage, and the node respectively.

20. The circuit according to claim 19, wherein the first transistor is a P-channel MOS transistor, and the second transistor is an N-channel MOS transistor.

21. The circuit according to claim 16, wherein the bias circuit comprises:
a first current mirror, coupled to the first voltage, comprising:
a first transistor, comprising a first terminal couple to the first voltage, and a second terminal and a gate coupled to the second terminal; and
a second transistor, comprising a first terminal and a gate coupled to the first terminal and the gate of the first transistor respectively;
a second current mirror, coupled between the first current mirror and the second voltage, comprising:
a third transistor, comprising a first terminal and a second terminal coupled to the second terminal of the first transistor and the second voltage respectively; and
a fourth transistor, comprising a first terminal and a gate coupled to the second terminal of the second transistor, and a second terminal coupled to the second voltage, wherein the third transistor and the fourth transistor have different channel width/length ratios, wherein the bias circuit is used to provide a stable bias.

22. The circuit according to claim 21, wherein when the first terminal of the third transistor receives the start-up voltage, the bias circuit transits from a zero stable state to a saturated stable state and provides the stable bias.

23. The circuit according to claim 22, wherein the start-up voltage is the second voltage.

24. The circuit according to claim 21, wherein when the first terminal of the fourth transistor receives the start-up voltage, the bias circuit transits from a zero stable state to a saturated stable state and provides the stable bias.

25. The circuit according to claim 24, wherein the start-up voltage is the first voltage.

26. The circuit according to claim 21, wherein the first and second transistors are P-channel MOS transistors, and the third and fourth transistors are N-channel MOS transistors.

27. The circuit according to claim 16, wherein the impedance unit comprises:
a resistor, coupled between the first voltage and the node.

28. The circuit according to claim 16, wherein the charge storage unit comprises:
a capacitor, coupled between the node and the second voltage, wherein the start-up voltage is output to the bias circuit when the capacitor is at a charge state, and the outputting of the start-up voltage to the bias circuit is stopped when the capacitor is at a saturated state.

29. The circuit according to claim 16, wherein the charge storage unit comprises:
a first transistor, comprising a first terminal and a second terminal coupled to the second voltage, and a gate coupled to the node.

30. The circuit according to claim 16, wherein the switch comprises:
a first transistor, comprising a first terminal, a second terminal, and a gate coupled to the bias circuit, a third voltage, and the node respectively, wherein whether or not to conduct the first terminal and the second terminal of the first transistor is decided according to the voltage of the node.

31. A start-up method for a bias circuit, comprising:
charging a charge storage unit through an impedance unit;
outputting the start-up voltage to the bias circuit when the charge storage unit is at a charge state; and
stopping outputting the start-up voltage to the bias circuit when the charge storage unit is at a saturated state.

32. The start-up method for a bias circuit according to claim 31, wherein when the charge storage unit is at a charge state, a node coupled to the charge storage unit is at a first voltage so as to turn on a switch to allow outputting the start-up voltage to the bias circuit.

33. The start-up method for a bias circuit according to claim 32, wherein when the charge storage unit is at a saturated state, the node is at a second voltage so as to turn off the switch to stop outputting the start-up voltage to the bias circuit.
